(19) United States
(12) Patent Application Publication
(10) Pub. No.: US 2008/0199012 A1
(43) Pub. Date: Aug. 21, 2008

(54) Method for identifying a server device in a network

(75) Inventor: Tadafusa Niinomi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/071,176

(22) Filed: Feb. 15, 2008

(30) Foreign Application Priority Data
Feb. 19, 2007 (JP) 2007-038549

(51) Int. Cl. H04L 9/06; G06F 15/177

(52) U.S. Cl. 380/277; 709/220

(57) ABSTRACT

According to an aspect of an embodiment, an apparatus connectable to a storage device through a network, comprising: a network interface module for connecting the apparatus to the storage device through the network; a memory for storing identification information identifying said network interface module in said network; a receiving module for receiving set up information including identification information identifying said network interface module through said network; and a controller for writing said identifying information into the memory on the basis of said set up information.

### TECHNICAL FIELD

The present invention relates to servers.

Some server systems are constituted by a server and a storage device, which are independent from one another. As such server systems, a storage area network (SAN) is known. In some server systems, a function is provided, for example, by a plurality of servers operating in cooperation with each other, and a mass storage device are shared among a plurality of servers. In the SAN, storages devices, which are traditionally managed separately for each server, are integrated, thereby separating storage management from server management. In addition, the SAN can flexibly assign a storage resource to servers. The SAN is constituted using a technology, such as Fibre Channel or Ethernet.

Obsolete servers or faulty servers (hereinafter, referred to as pre-replacement servers) are replaced by new servers (hereinafter, referred to as post-replacement servers). Network identifiers of the post-replacement servers have to match those of pre-replacement servers since storage devices to be connected thereto are decided according to the identifiers of the servers. Accordingly, gateways are required to manage correspondences between identifiers of the pre-replacement servers and identifiers of the post-replacement servers and to relay communication between the servers and the storage devices. However, gateways are expensive, thus leading to an increase in the entire cost of a server system.

Japanese Unexamined Patent Application Publication Nos. 2000-134339 and 2001-249908 disclose techniques in the related art.

### SUMMARY

According to an aspect of an embodiment, an apparatus connectable to a storage device through a network, comprising: a network interface module for connecting the apparatus to the storage device through the network; a memory for storing identification information identifying said network interface module in said network; a receiving module for receiving set up information including identification information identifying said network interface module through said network; and a controller for writing said identifying information into the memory on the basis of said set up information.

### BRIEF DESCRIPTION OF THE DRAWINGS

FIG. 1 is a system configuration diagram of a server system 1 according to an embodiment of the present invention;

FIG. 2 is a configuration diagram of a server 2 according to an embodiment of the present invention;

FIG. 3 is a flowchart of a process executed by a management server according to a first example;

FIG. 4 is an example structure of a rewriting PDU;

FIG. 5 is a flowchart of a process executed by a network interface 24 of a replacing server according to a first example;

FIG. 6 is a flowchart of a process executed by a management server 4 of a server system 1 in the case of Fibre Channel;

FIG. 7 is a flowchart of a process executed by an HBA of a replacing server;

FIG. 8 is a configuration diagram of a server 2 according to a second example;

FIG. 9 is a flowchart of a process executed by a network interface 24 of a replacing server according to a second example;

FIG. 10 is a configuration diagram of a server 2 according to an embodiment that employs public key information;

FIG. 11 is a flowchart of a process according to an embodiment that employs an authentication function;

FIG. 12 is an example structure of a rewriting PDU used in a case of adopting an authentication function;

FIG. 13 is a flowchart of a process executed by a replacing server in a case of adopting an authentication function;

FIG. 14 is an example of a configuration of a replacing server in a case of adopting a packet-reuse preventing function in addition to an authentication function;

FIG. 15 is a structure of a rewriting PDU used in a case of adopting a packet-reuse preventing function in addition to an authentication function;

FIG. 16 is a flowchart of a process executed by a replacing server in a case of adopting a packet-reuse preventing function in addition to an authentication function;

FIG. 17 is an example of a configuration of a server system 1 that prevents a rewriting PDU from being reused using a serial number;

FIG. 18 is a flowchart of a process executed by a management server 4 in a case of preventing a rewriting PDU from being reused using a serial number;

FIG. 19 is an example structure of a rewriting PDU;

FIG. 20 is a flowchart of a process executed by a replacing server in a case of preventing a rewriting PDU from being reused using a serial number;

FIG. 21 is an example of a configuration of a replacing server in a case of making a replacing network identifier invisible in a rewriting PDU;

FIG. 22 is a flowchart of a process executed by a management server 4 in a case of making a replacing network identifier invisible in a rewriting PDU; and

FIG. 23 is a flowchart of a process executed by a replacing server in a case of making a replacing network identifier invisible in a rewriting PDU.

### DESCRIPTION OF THE PREFERRED EMBODIMENTS

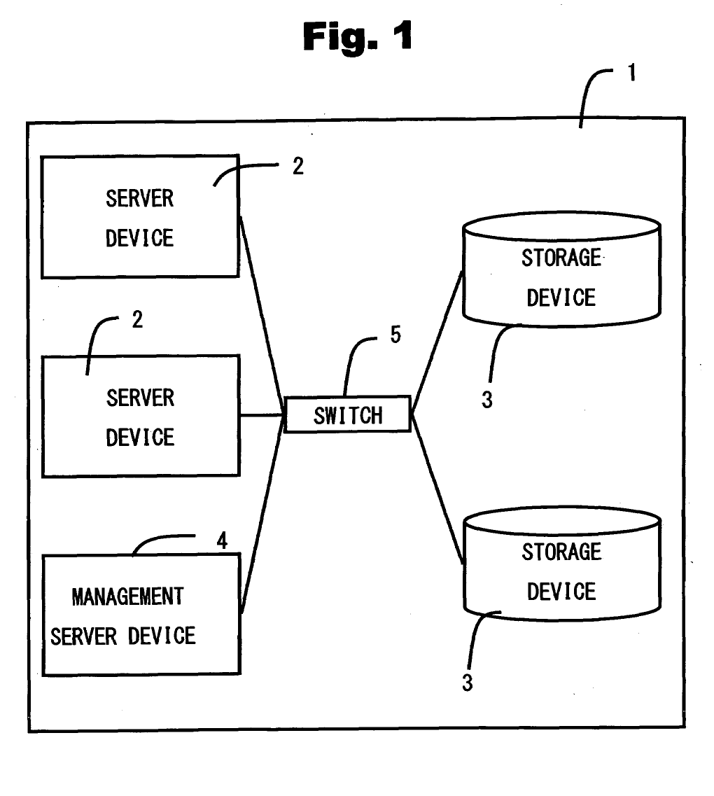

FIG. 1 is a system configuration diagram of a server system 1 according to an embodiment of the present invention.

The server system 1 constitutes a network including servers 2, storage devices 3, and a switch 5. The servers 2 instruct writing and reading of data in and from the storage devices 3. In response to the data reading instruction or the data writing instruction accompanied with data given from the servers 2, the storage devices 3 perform a data reading operation or a data writing operation. The storage devices 3 according to the embodiment store an operating system (OS) used in the servers 2.

In communication through a network, data to be transmitted is divided into a predetermined size and is transmitted in a unit of the divided data. The divided data is attached with control information needed by a source device, a destination device, and a switch. A unit of transmission data constituted by the divided data and the control information is referred to as a protocol data unit (PDU). The format of the PDU differs depending on transmission/reception protocols. In the transmission control protocol/Internet protocol (TCP/IP), the PDU corresponds to a packet. Additionally, in Ethernet and Fibre Channel, the PDU corresponds to a frame.

In the server system 1, the servers 2 or the storage devices 3 transmit a PDU attached with an identifier over a network (i.e., a network identifier) of a destination device through a network, thereby transmitting information to the destination device. In Ethernet, a PDU can include a network identifier belonging to a communication module (e.g., a network interface) of a server. In Fibre Channel, another network identifier corresponding to a network identifier of a communication module of a server is acquired from a switch at an initial stage of the communication and a PDU can include the acquired network identifier. For convenience of explanation given below, one of the servers 2 is set as a management server 4. The management server 4 transmits a PDU used for replacement of a network identifier of a server 2. In the description below, a server 2 whose network identifier is replaced by the management server 4 is referred to as a replacing server. In addition, in the description below, a PDU used for changing the network identifier is referred to as a rewiring PDU. Additionally, the management server 4 does not have to be limited to a particular server 2 included in the server system 1.

The network identifier used in the embodiment differs depending on configurations of the server system 1. For example, when the server system 1 is constituted using Fibre Channel, which is a standard for connection of a mass storage system, a world wide name (WWN) of a host bus adapter (HBA) included in each server 2 or each storage device 3 is used as the network identifier in the server system 1. The WWN is a 64-bit unique identification number assigned to the HBA. There are two types of WWN, namely, a world wide port name (WWPN) and a world wide node name (WWNN). In Fibre Channel, another network identifier called a port address related to this WWN according to a network to be connected is acquired from the switch 5 through a method called login at the time of a start of communication, and communication is performed using the acquired port address. In the description below, the network identifier used in description regarding Fibre Channel means the WWPN unless otherwise noted.

In addition, when the server system 1 is constituted using Ethernet, a media access control (MAC) address of a network interface card (NIC) included in a server is used as a network identifier in the server system 1. The MAC address is an identification number uniquely assigned to the NIC. In connection of a network using Ethernet, the servers 2 and the storage devices 3 are connected to each other using Internet small computer system interface (iSCSI). The iSCSI is a standard for allowing a SCSI protocol to be used over a TCP/IP network. In an IP protocol used in the TCP/IP and an iSCSI protocol used over the TCP/IP, a network identifier called an IP address and a network identifier called an iSCSI name are used, respectively. Hereinafter, a network identifier mentioned in description regarding Ethernet means the MAC address unless otherwise noted. Although replacement of a MAC address and a WWN (WWPN or. WWNN) will be mainly described hereinafter, the present invention is not limited by kinds of these network identifiers.

The server system 1 may be constituted using both Fibre Channel and Ethernet.

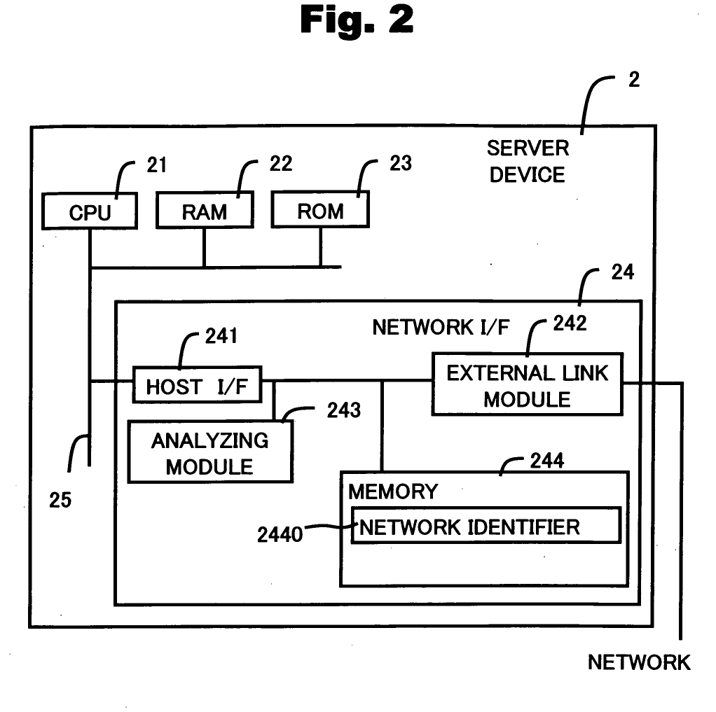

A configuration of the server 2 will be described next. FIG. 2 is a configuration diagram of the server 2 according to an embodiment of the present invention. The server 2 includes a central processing unit(CPU) 21, a random access memory (RAM) 22, a read only memory (ROM) 23, and a network interface (I/F) 24, which are connected to each other through a bus 25.

The CPU 21 controls the entirety of the server 2. The CPU 21 also executes programs loaded into the RAM 22. The RAM 22 is a storage area to which an OS and application programs received from the storage device 3 are loaded. In addition, the CPU 21 executes processing for creating a rewriting PDU used for changing a network identifier of a replacing server. The ROM 23 stores information on settings of the server 2. The CPU 21 executes various control operations according to the setting information stored in the ROM 23.

The network interface (I/F) 24 is an interface for allowing the server 2 to be connected to a network of the server system 1. When the network interface 24 can be seen as a SCSI device from the OS, the network interface 24 is referred to as an HBA. On the other hand, when the network interface 24 can be seen as an NIC from the OS, the network interface 24 is referred to as an NIC. In a case where a server is connected to a network using Fibre Channel, the network interface 24 is generally considered as an HBA in Fibre Channel. On the other hand, in a case where a server is connected to a network using Ethernet, the network interface 24 can be considered as an NIC or an HBA. In addition, in a case where a server is connected using iSCSI over Ethernet, there are an implementation in which the network interface 24 can be seen as an NIC from the OS and an implementation in which the network interface 24 can be seen as an HBA from the OS. In examples given below, in the case of Ethernet, description will be mainly given for an example case where the network interface 24 can be considered as an NIC. However, the present invention can be also applied to a case where the network interface 24 can be considered as an HBA.

The network interface 24 according to this embodiment includes means for allowing the network identifier of the server 2 to be rewritten from the management server 4. The network identifier rewriting operation is performed before the server 2 is booted. The state in which the server 2 has not been booted corresponds to a power standby state in which the CPU 21 of the server 2 is not operating. In that state, the network interface 24 receives a PDU through the network, and rewrites an identifier of the network interface 24.

The network interface 24 includes a host interface module 241, an external link module 242, an analyzing module 243, and a memory 244.

The host interface module 241 is connected to the bus 25 included in the server 2. The host interface module 241 receives information to be transmitted to the server system 1 from the bus 25, and transmits information received from the server system 1 to the bus 25. The external link module 242 is connected to an external network. There are various types of link modules. For example, in the case of optical signal link, the link module converts an optical signal into an electric signal. In addition, the link module may have a function, such as serial conversion or parallel conversion. The analyzing module 243 analyzes information included in the PDU received from the server system 1. For example, the analyzing module 243 determines whether or not the received PDU is directed to this network interface 24. In addition, the analyzing module 243 determines whether or not the PDU is for changing the network identifier of the network interface 24 and whether or not the PDU is the rewriting PDU. The memory 244 has an area 2440 for storing the network identifier of this network interface 24.

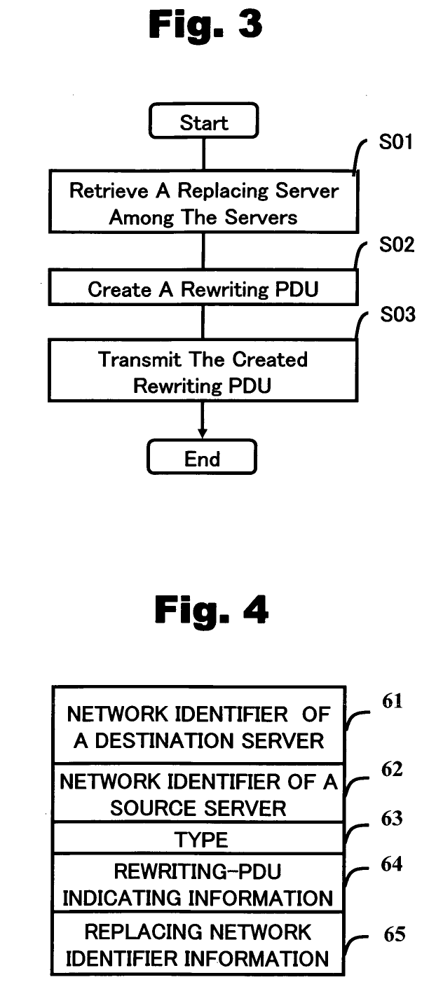

A process for changing a network identifier of the server 2 in the server system 1 will be described next. FIG. 3 is a flowchart showing a process executed by a management server according to a first example.

The management server 4 retrieves a replacing server among the servers 2 (S01). The replacing server is a backup server that is operated instead of a faulty server when the server currently operating in the server system 1 breaks down. The replacement means changing a network identifier of a replacing server to a network identifier of the faulty server in the server system 1.

The management server 4 creates a rewriting PDU used for changing the network identifier of the replacing server (S02). FIG. 4 shows an example structure of a rewriting PDU. The rewriting PDU includes a network identifier 61 of a destination server 2, a network identifier 62 of a source server 2, a frame type 63 indicating a type of data protocol, information 64 indicating that this PDU is a rewriting PDU (hereinafter, referred to as rewriting-PDU indicating information 64), and information 65 on a network identifier by which the original identifier is replaced (hereinafter, referred to as replacing network identifier information 65). The management server 4 transmits the created rewriting PDU to the server system 1 (S03).

The rewriting-PDU indicating information 64 is set, for example, as follows. In the case of communication using user datagram protocol (UDP), a packet is used as a PDU. Thus, an administrator sets a special port number that indicates this packet is a packet for rewriting a MAC address beforehand. The NIC of the replacing server determines whether or not the received packet is the rewriting PDU according to whether or not the port number included in the received packet is the special port number.

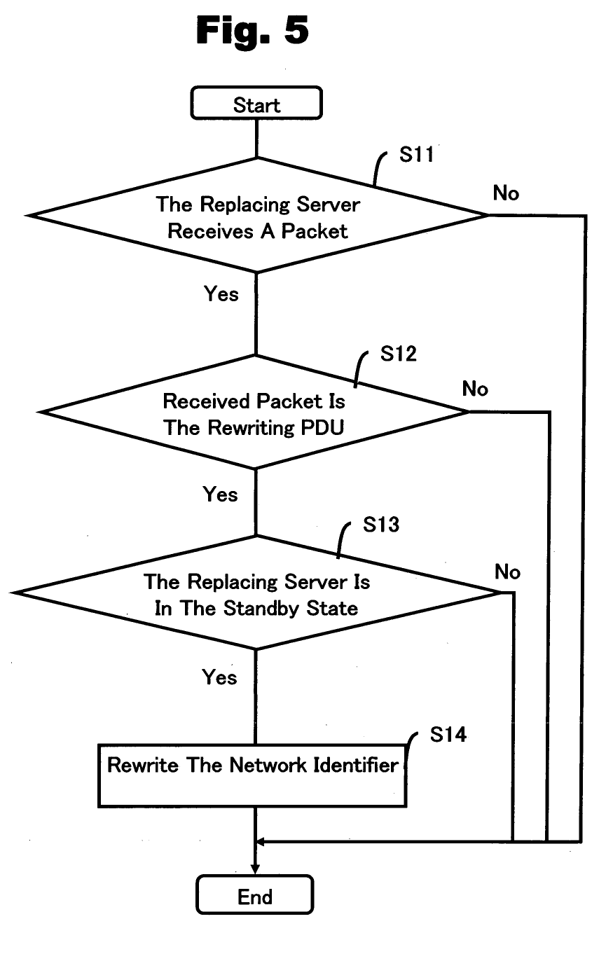

An operation of the replacing server will be described next. FIG. 5 is a flowchart showing a process executed by the network interface 24 of the replacing server according to a first example.

The network interface 24 of the replacing server receives a packet from the server system 1 (S11). Upon receiving a packet directed to this network interface 24 (YES of S11), the network interface 24 determines whether or not the received packet is the rewriting PDU (S12) In the case of Ethernet, the network interface 24 determines whether or not the received PDU is directed to this network interface 24 according to whether or not the network identifier of the destination server included in the PDU matches the network identifier stored in the memory 244. In the case of Fibre Channel, the network interface 24 determines whether the received PDU is directed to this network interface 24 according to whether or not a port address of the destination server included in the PDU matches the port address stored in the memory 244. In addition, the network interface 24 determines whether or not the received PDU is the rewriting PDU according to existence or absence of the rewriting-PDU indicating information 64.

If the network interface 24 determines that the received PDU is the rewriting PDU (YES of S12), the network interface 24 determines whether or not the replacing server is in the standby state. The replacing server may be in the operation state or may be in the standby state. The standby state means a state in which the server is not booted, i.e., a state in which a predetermined level of power is supplied to the server but the CPU of the server is not executing a process, such as an OS. It is convenient to change the network identifier in the standby state since it can be considered that the replacing server serving as a backup server is often in the standby state. If the network identifier were able to be rewritten only after this backup server is booted, a time for booting the backup server is required for the rewriting. In addition to the time for booting, a disk image (an OS on a disk or the like) is needed for booting the backup server prior to the rewriting. To boot the backup server using the disk image, some kind of dummy network identifier is necessary. The care must be taken in selecting the dummy network identifier so that the dummy network identifier does not overlap with network identifiers of other servers. Such a system can be an inconvenient system. In addition, depending on types of the network, rewriting of a network identifier of a network interface of a server while the server is operating may disable the server to perform communication. Even in networks that technically allow the rewriting during the operation, users of the networks may feel uneasy about performing such an action. Based on such points, it is advantageous to rewrite a network identifier in a standby state.

When the replacing server is in the standby state (YES of S13), the network interface 24 rewrites the network identifier 2440 stored in the memory 244 using the network identifier included in the rewriting packet (S14).

When the replacing server is not in the standby state, rewriting of the network identifier can be executed by the network interface 24 in synchronization with booting of the replacing server. When the network interface 24 updates the network identifier in synchronization with booting of the replacing server, an area for temporarily storing a network identifier included in the received rewriting PDU is prepared in the memory 244 of the network interface 24.

At the time of booting of the replacing server, the network interface 24 of the replacing server rewrites the network identifier stored in the memory 244 using the network identifier temporarily stored in the prepared area. By configuring the network interface 24 not to rewrite the network identifier until booting of the server even if the network interface 24 receives the rewriting PDU while the replacing server is operating, the replacing server can perform communication using an original network identifier until the replacing server is booted. As a result, the network identifier is changed only at the time of booting of the replacing server. Thus, the management server 4 can transmit a rewriting PDU even while the replacing server is operating and it is possible to boot the replacing server using the network identifier rewritten at the time of rebooting of the replacing server. In addition, in the case where some packets have to be exchanged in communication necessary for the rewriting, the communication can be continued using the original network identifier while the communication for the rewriting is being performed.

A case where the server system 1 is connected using Ethernet will be described next using FIGS. 4 and 5. In the case of Ethernet, an NIC serves as the network interface 24 of the server 2. In addition, a packet is used as a PDU. Furthermore, a rewriting packet is transmitted using UDP.

The management server 4 retrieves a MAC address of an NIC of a replacing server (S01), and creates a rewriting packet (S02).

The management server 4 sets a port number that indicates the rewriting packet in an area of the rewriting packet for specifying the port number, and creates the rewriting packet. The management server 4 sets the PDU type 63 to UDP. In the case of UDP, the rewriting-packet indicating information 64 can be determined using, for example, a port number. An application for providing a service executed by a server has a port number unique to the application. Other serves or clients transmit packets to a network identifier, an IP address, and a port number of a server, thereby performing communication. Accordingly, by previously setting a port number that indicates that this packet is a rewriting packet, the analyzing module 243 of the NIC can determine whether or not the received packet is the rewriting packet. The management server 4 stores a replacing MAC address in an area 65 of the rewriting packet for storing a network identifier to which the original identifier is replaced. The management server 4 sets a MAC address of the NIC of the replacing server as a network identifier 61 of the destination server.

The management server 4 sets a MAC address thereof as a network identifier 62 of the source server, and transmits the rewriting packet (S03).

The NIC of the replacing server is capable of receiving power necessary for each processing module of the NIC to execute processing even if the server is in the standby state and of receiving and transmitting packets through a network.

Upon the NIC receiving a packet (S11), the analyzing module 243 determines whether or not the received packet is the rewriting packet on the basis of the destination and the UDP port number (S12). The analyzing module 243 then determines whether the replacing server is in the standby state or in the operation state (S13). If the analyzing module 243 determines that the replacing server is in the standby state (YES of S13), the analyzing module 243 rewrites the MAC address stored in the memory 244 to an MAC address specified in the rewriting packet (S14).

A case where the server system 1 is connected using Fibre Channel will be described using FIGS. 4 and 5. An HBA serves as the network interface 24 of the server 2. In addition, a frame is used as a PDU.

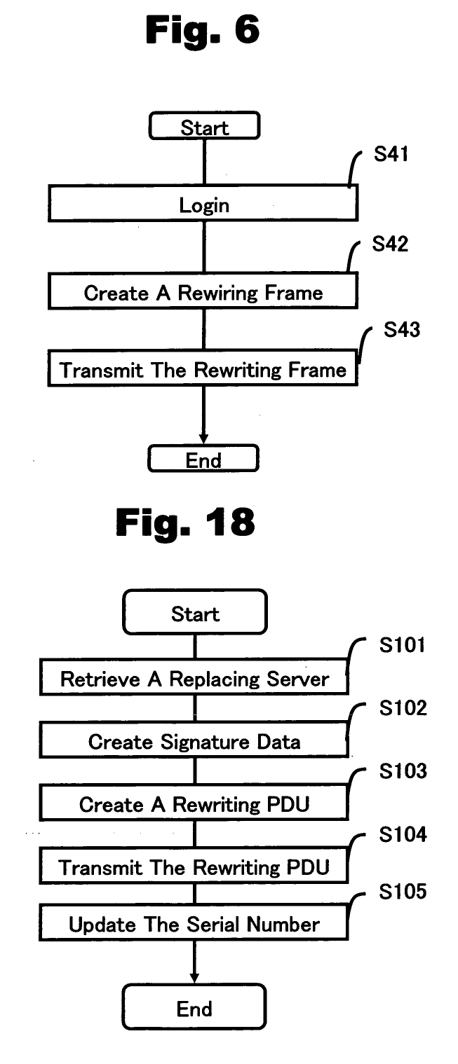

FIG. 6 is a flowchart showing a process executed by the management server 4 of the server system 1 in the case of Fibre Channel. In this embodiment, it is assumed that fabric connection is employed as a connection mode of Fibre Channel. The present invention can be also applied to a case where a connection mode of Fibre Channel is a loop topology. The description will be given for a case where a fabric device is used as the switch 5 of the server system 1. The server connected to Fibre Channel has completed Fibre Channel login (i.e., fabric login (FLOGI)) to the fabric device even if the server is in the standby state. After the completion of fabric login, the management server 4 inquires of a name server of the fabric device for a port address of a replacing server, and performs a Fibre Channel login operation (i.e., port login (PLOGI)) to the replacing server using the port address (S41). The name server is a table that stores a WWPN of each device connected to the server system 1 in association with a port address.

The management server 4 creates a rewiring frame (S42). The rewriting frame to be transmitted includes a port address associated with a WWPN of an HBA of the replacing server as a network identifier 61 of a destination server, a port address associated with a WWPN of an HBA of the management server 4 as a network identifier 62 of a source server, a predetermined type field value indicating the rewriting frame as a type 63, and a WWPN to which the network identifier is replaced as information on a replacing network identifier 65. The rewriting-frame indicating information 64 is equivalent to the type 63 in this example case.

An area called a type field included in the frame is used to indicate whether or not this frame is the rewriting frame. An administrator previously sets a type field value that indicates that this frame is the rewriting frame. The rewriting packet can be specified in an upper layer protocol instead of defining whether or not the packet is the rewriting packet in the type field.

In addition, a method for sending back the WWPN rewritten by the HBA of the replacing server to allow the management server 4 to know whether or not the rewriting operation of the WWPN of the HBA of the replacing server is surely performed is also possible.

The management server 4 then transmits the rewriting frame to the server system 1 (S43).

An operation of the HBA of the replacing server will be described next.

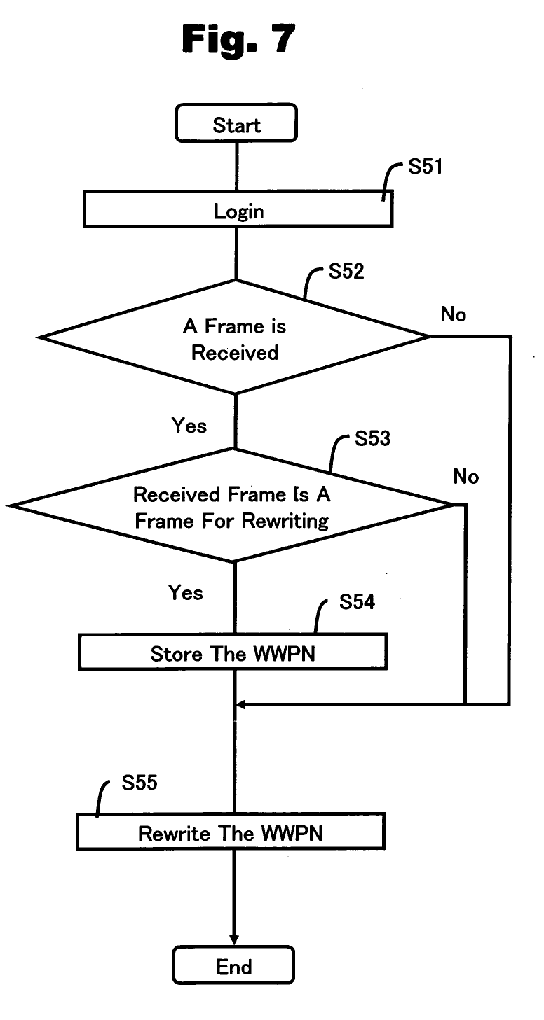

FIG. 7 is a flowchart of a process executed by the HBA of the replacing server.

In the case of Fibre Channel, it is assumed that the fabric login process has been completed in the servers 2 or the storage devices 3 connected to the fabric device prior to execution of a communication process according to this embodiment. After the fabric login, a procedure called port login for exchanging information such as WWN between the HBA of the management server 4 and the HBA of the replacing server is necessary as described above. The management server 4 performs the port login to the HBA of the replacing server (S51).

The HBA of the replacing server receives a frame transmitted from the management server 4 (S52). The HBA of the replacing server determined whether or not the frame is directed thereto according to whether or not the port address stored in the memory 244 of the HBA matches the port address of the destination server included in the received frame. The analyzing module 243 of the HBA determines whether or not the received frame is a frame for rewriting of a WWPN (hereinafter, referred to as a rewriting frame) (S53). At the time of performing communication thereafter, login and communication with a name server are carried out using the newly rewritten WWPN, and communication is performed using a port address associated with the WWPN.

If the frame received by the replacing server is the rewriting frame (YES of S53), the analyzing module 243 of the HBA stores the WWPN included in the received frame in a storage area of the memory 244 (S54). The analyzing module 243 of the HBA of the replacing server rewrites the WWPN used by the replacing server to the WWPN included in the received frame (S55).

A case where a network identifier of the network interface 24 and a network identifier used by the replacing server are separately stored-before the replacing server is booted will be described next.

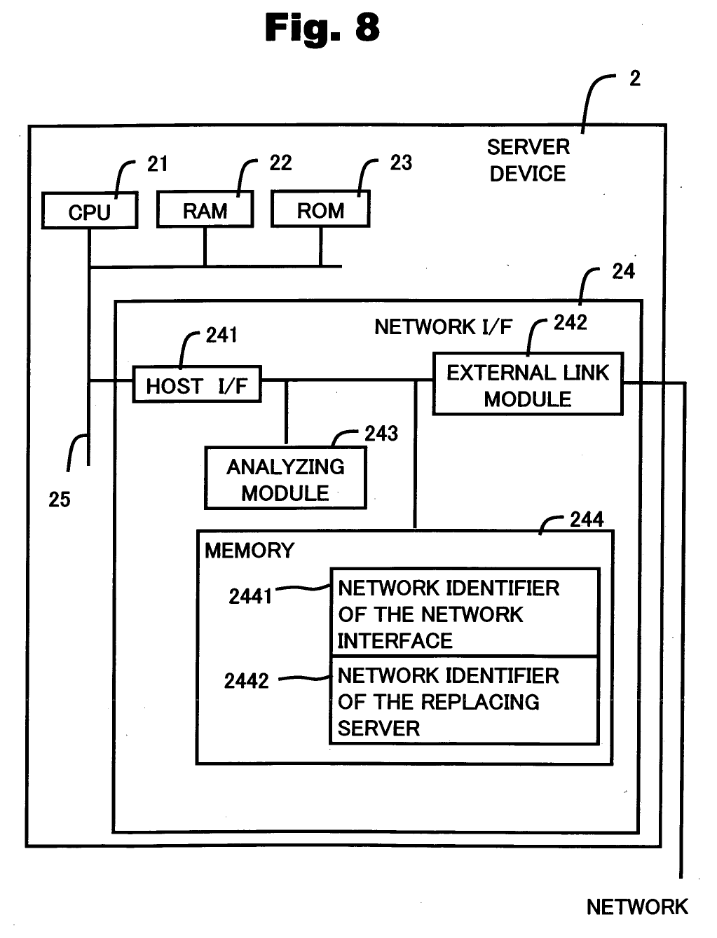

FIG. 8 is a configuration diagram of a server 2 according to a second example. In the second example, a memory 244 of a network interface 24 has two areas, i.e., an area 2441 for storing a network identifier of the network interface 24 and an area 2442 for storing a network identifier of the replacing server. Other configurations are similar to those of the server 2 according to the first example.

The network identifier of the network interface 24 stored in the area 2441 is used when the network interface 24 independently access the server system 1. For example, when the server 2 is in the standby state, the network interface 24 is identified by the server system 1 on the basis of the network identifier stored in the area 2441. On the other hand, the network identifier of the replacing server stored in the area 2442 is used when the replacing server access the server system 1 through the network interface 24. For example, while the server 2 is operating, the server 2 is identified by the server system 1 on the basis of the network identifier of the replacing server stored in the area 2442.

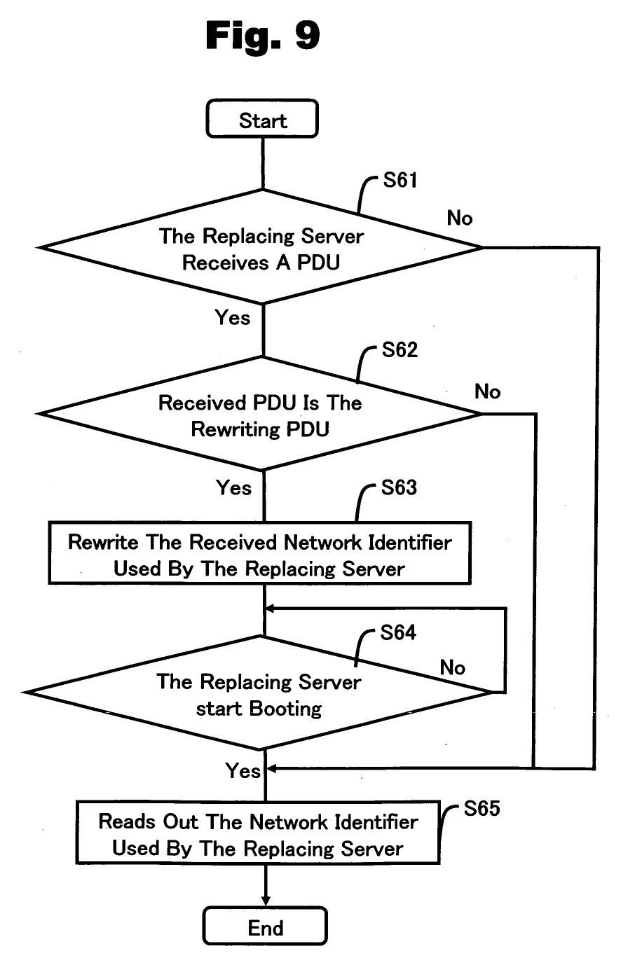

FIG. 9 is a flowchart showing a process executed by the network interface 24 of the replacing server according to the second example. Processing for creating and transmitting a rewriting PDU performed by the management server 4 is similar to that shown in FIG. 3, thus the description thereof is omitted.

The network interface 24 of the replacing server receives a PDU from the management server 4 (S61). If the network interface 24 receives a PDU directed to a network identifier thereof (YES of S61), the network interface 24 determines whether or not the received PDU is the rewriting PDU (S62). If the network interface 24 determines that the received PDU is the rewriting PDU (YES of S62), the analyzing module 243 of the network interface 24 of the replacing server rewrites the received network identifier in the memory area 2442 that stores the network identifier used by the replacing server (S63).

Upon the network interface 24 receiving information on a start of booting of the replacing server (YES of S64), the CPU 21 of the server reads out the network identifier used by the replacing server stored in the storage area 2442 of the memory 244 of the network interface 24 at the time of booting of the server (S65). At the time that the CPU 21 of the replacing server boots the OS, the CPU 21 of the replacing server performs communication with the storage device 3 using the rewritten network identifier to boot the OS.

For example, the following methods are used as methods for acquiring a network identifier of a storage device corresponding to each server in the server system 1. In the IP-based protocol using Ethernet, it is possible to connect the server to a destination storage device using information acquired from the DHCP server by inquiring of a DHCP server (for example, a management server) for an IP address and a MAC address of a server having a disk image corresponding to the MAC address. In the case of Fibre Channel, a method for further setting a WWN of a destination server using a rewriting packet can be considered. Additionally, in the case of Ethernet, when a server and a storage device are connected to each other using an iSCSI protocol, a method for setting an iSCSI name of a destination server using a rewriting packet can be considered.

In the above described embodiment, any one of servers 2 connected to the server system 1 can rewrite a network identifier of a replacement-server. Accordingly, a server that gives an instruction of rewriting identifiers is specified and the network interface 24 of the replacing server authenticates the validity only when a received PDU is transmitted from the management server 4.

A method for allowing only the management server 4 to change a network identifier of the server 2 will be described below. In a third example, a case where a management server 4 and a replacing server have an authentication function will be described. The description will be given for an example in which the authentication function employs a public key cryptography.

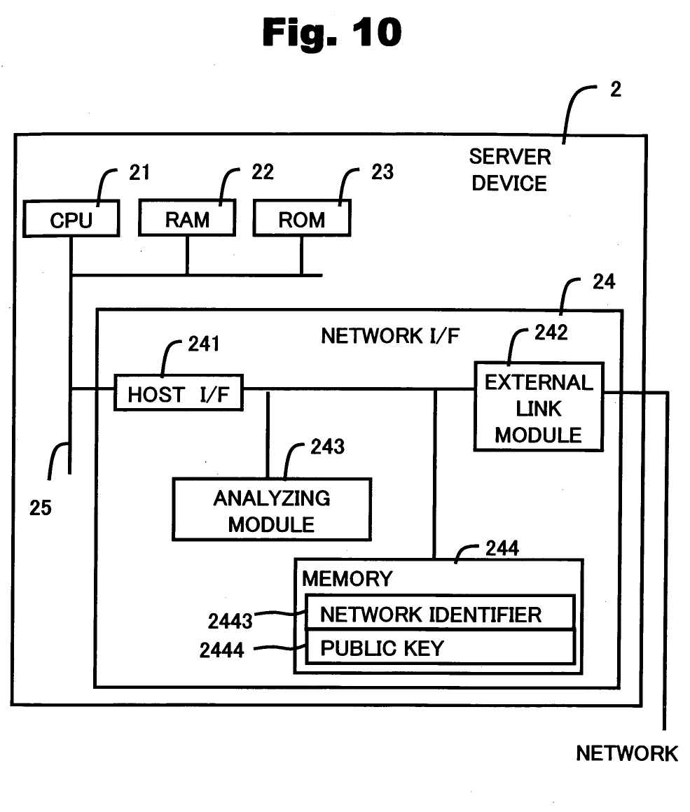

FIG. 10 is a configuration diagram of a server 2 having public key information according to an embodiment of the present invention.

A network interface 24 of the replacing server has an area for storing public key information 2444 in a memory 244.

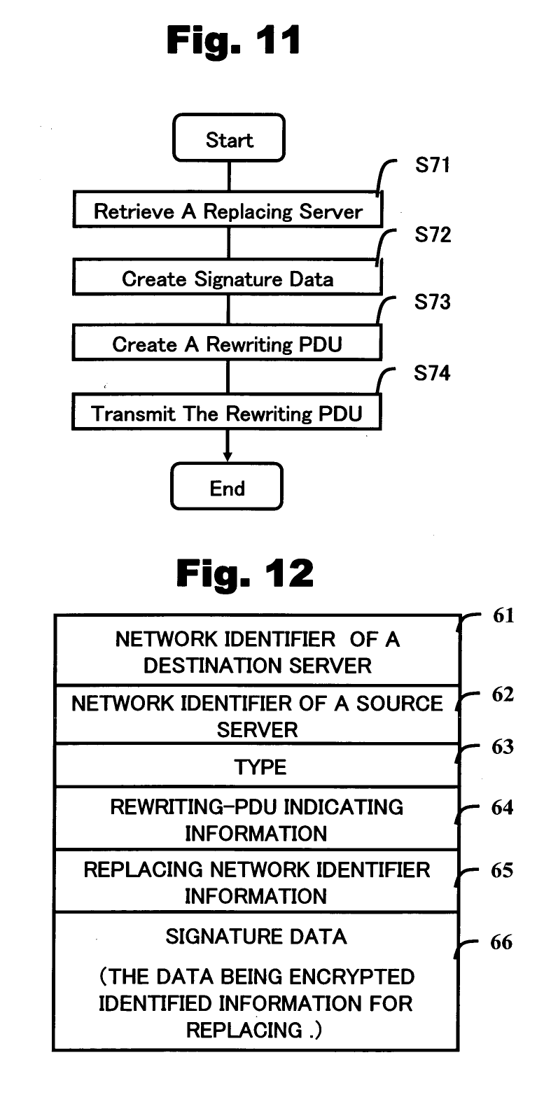

FIG. 11 shows a flowchart according to this embodiment in which the authentication function is adopted. The management server 4 retrieves a replacing server (S71). The management server encrypts data including a network identifier of the replacing server using a secret key previously assigned to the management server 4 to create signature data (S52). Data used for creating a signature may include a network identifier of a network interface 24 of the management server 4 or the replacing server, and a control signal of an upper layer protocol, such as for example, an IP address, as well as a network identifier of a replacement target. In addition, identification information or organization information of an administrator performing the rewriting operation can be included. When the size of the signature data becomes large, a digest of the signature data may be created and a signature may be attached to the digest. For example, the digest is random numbers that maintains a correspondence between an original text and a digest and that has the size smaller than the original text. The digest is created from the original text using, for example, a hush function. The management server 4 creates a rewriting PDU including rewriting-PDU indicating information 64, such as a port number, replacing network identifier information 65, and the created signature data 66 (S73). FIG. 12 shows a structure of a rewriting PDU used in a case where servers have an authentication function. The management server 4 then transmits the rewriting PDU to an NIC of the replacing server (S74).

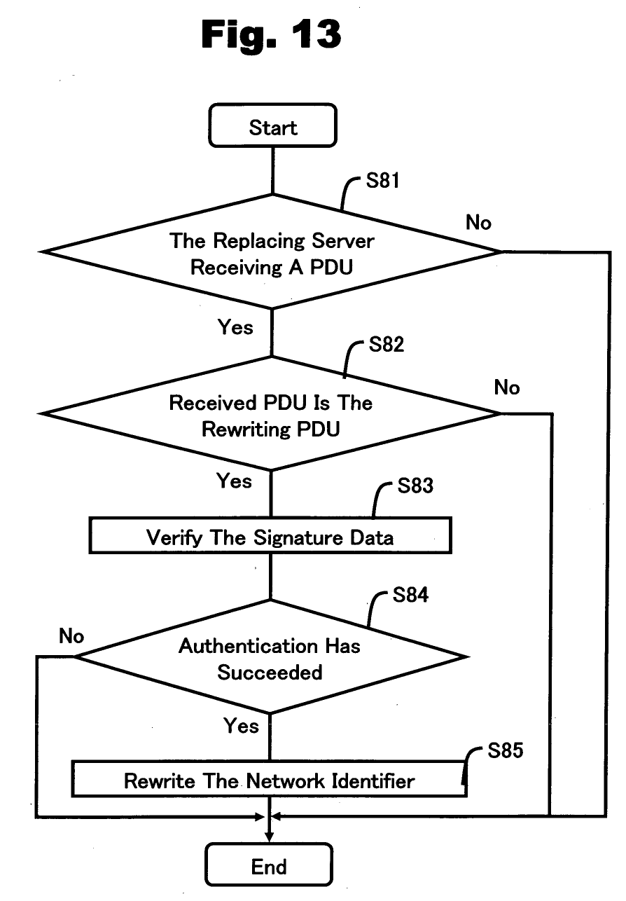

FIG. 13 is a flowchart of a process performed by the replacing server when the server has an authentication function. Upon the network interface 24 of the replacing server receiving a PDU (YES of S81), an analyzing module 243 determines whether or not the received PDU is the rewriting PDU (S82).

If the received PDU is the rewriting PDU (YES of S82), the analyzing module 243 verifies the signature data (S83). The verification of the signature data is performed by decrypting the signature data using the public key 2444 stored in the memory 244 and determining whether or not the network identifier included in the decrypted signature data matches the network identifier included in the rewriting PDU.

If the network identifiers match, the analyzing module 243 determines that the authentication has succeeded (YES of S84). The analyzing module 243 rewrites the network identifier 2443 stored in the storage area of the memory 244 to the network identifier included in the rewriting PDU (S85).

The above-described configuration can prevent a network identifier of the server 2 from being changed using an invalid rewriting PDU transmitted from an unspecified server 2.

A case of adopting packet-reuse preventing function in addition to the authentication function will be described next. It is possible to prevent a network identifier from being rewritten in response to an invalid rewriting packet transmitted from other servers 2 of the server system 1.

In the case of adopting the packet-reuse preventing function in addition to the authentication function, a server that executes invalid processing (hereinafter, referred to as an invalid server) executes following processing steps. The invalid server eavesdrops a rewriting PDU that flows over a network constituting the server system 1, and stores the rewriting PDU. The invalid server can rewrite a network identifier of another server 2 by transmitting the stored rewriting PDU at a given timing. In the case of adopting the packet-reuse preventing function in addition to the authentication function, reuse of a rewriting PDU by the invalid server is prevented by including information of a time during which rewriting of the network identifier of the replacing server is permitted in the rewriting PDU and by attaching a signature to data including the rewriting permitting time.

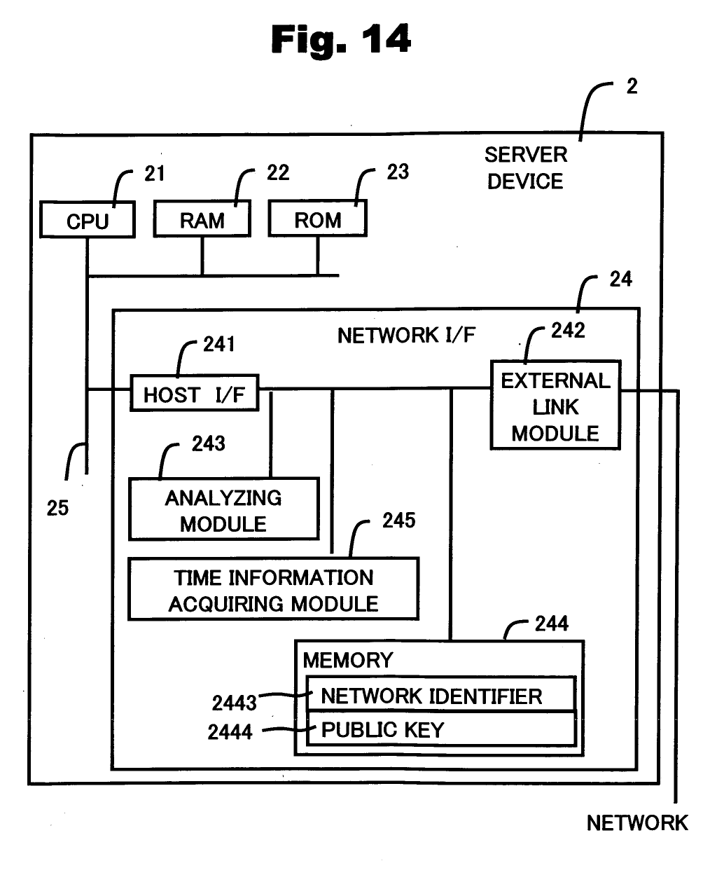

FIG. 14 is an example of a configuration of a replacing server in a case of adopting the packet-reuse preventing function in addition to the authentication function. A network interface 24 has a time information acquiring module 245 for acquiring time information. The time information acquiring module 245 includes a function of a clock or a function for acquiring the current time via a network of the server system 1. Other configurations of the server 2 are similar to those shown in FIG. 2, thus description thereof is omitted.

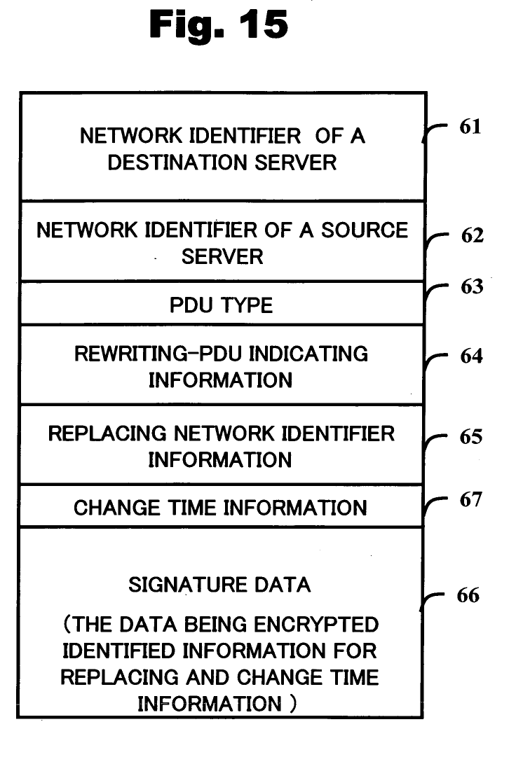

A process performed by the management server 4 in the case of adopting the packet-reuse preventing function in addition to the authentication function will be described. FIG. 15 shows a structure of a rewriting PDU used in the case of adopting the packet-reuse preventing function in addition to the authentication function. Referring back to the flowchart shown in FIG. 11, the management server 4 retrieves a replacing server (S71). The management server 4 includes information on rewriting permitting time in the signature data (S72). The management server 4 creates a rewriting PDU including a network identifier 61 of a destination server 2, a network identifier 62 of a source server 2, a type 63 indicating a type of data protocol, rewriting PDU indicating information 64, replacing network identifier information 65, change time information 67, and the signature data 66 (S73). The management server 4 then transmits the rewriting PDU (S74).

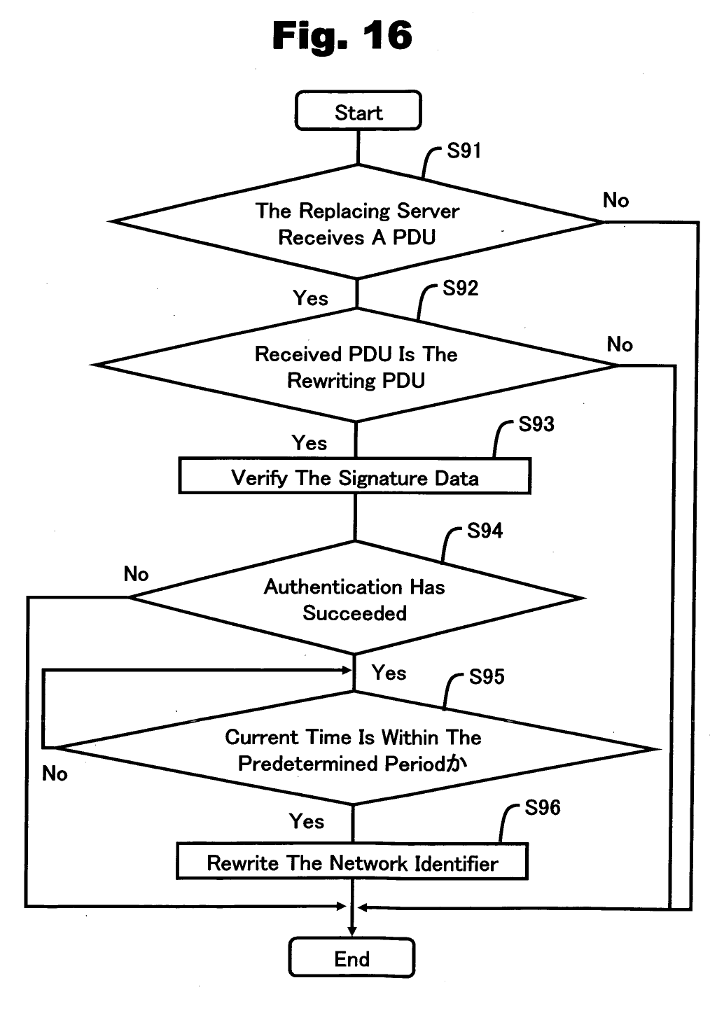

FIG. 16 is a flowchart of a process executed by a replacing server in the case of adopting the packet-reuse preventing function in addition to the authentication function.

Upon the network interface 24 of the replacing server receiving a PDU (YES of S91), the analyzing module 243 determines whether or not the received PDU is the rewriting PDU (S92).

If the received PDU is the rewriting PDU (YES of S92), the analyzing module 243 verifies the signature data (S93). The verification of the signature data is performed by decrypting the signature data using a public key 2444 stored in the memory 244 and determining whether or not the network identifier included in the decrypted signature data matches the network identifier included in the rewriting PDU.

If the network identifiers match, the analyzing module 243 determines that the authentication has succeeded (YES of S94).

The analyzing module 243 acquires the current time from the time information acquiring module 245. The analyzing module 243 determines whether or not the current time is a time after a time indicated by the change time information 67 included in the rewriting PDU and is a time before a time obtained by adding a predetermined change permitted period to the change time information 67 (S95). If the current time is within the predetermined period from the change time information 67 (YES of S95), the analyzing module 243 rewrites the network identifier stored in the storage area of the memory 244 to the received network identifier 65 (S96).

The above-described configuration can prevent a network identifier of the server 2 from being changed using an invalid rewriting PDU transmitted from an unspecified server 2. Furthermore, since changing of a network identifier using a rewriting PDU whose validity has expired is not permitted, it is possible to prevent the rewriting PDU from being reused. Additionally, a method for transmitting a rewriting PDU including the change time information 67 as well as change permitted period information is also available.

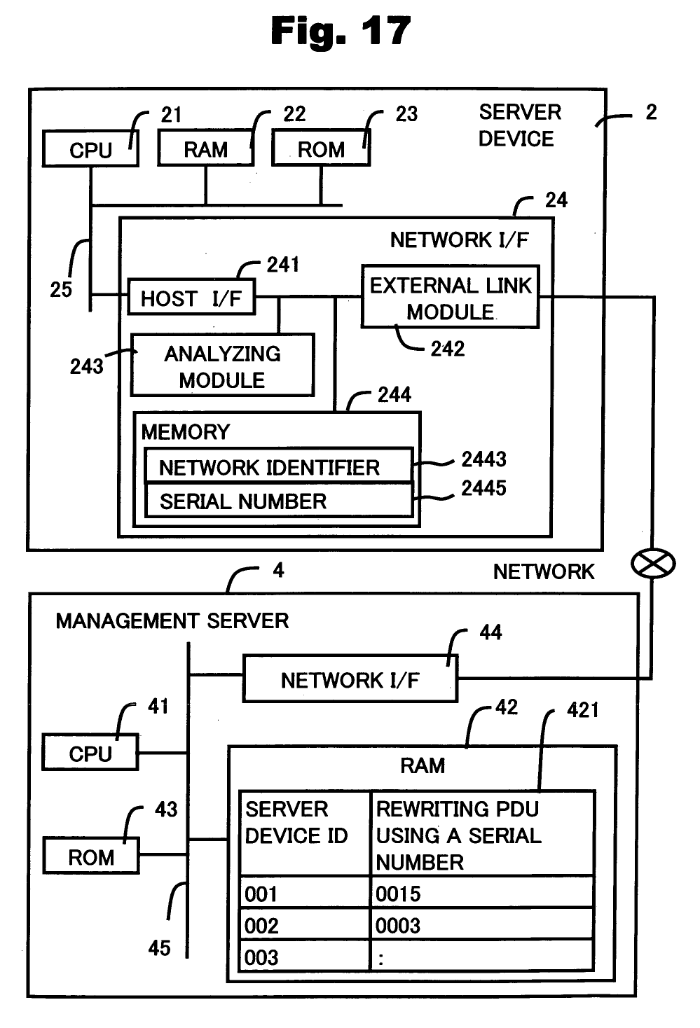

In addition, a method for preventing reuse of a rewriting PDU using a serial number instead of the time information is also available as a method for preventing reuse of the rewriting PDU. FIG. 17 shows an example of a configuration of a server system 1 for preventing reuse of a rewriting packet using a serial number. According to a method for preventing reuse of a rewriting PDU using the serial number, the management server 4 holds a serial number of a rewriting PDU transmitted to each server 2. The management server 4 includes a CPU 41, a RAM 42, a ROM 43, and a network interface 44, which are connected to each other through a bus 45. The CPU 41, the RAM 42, the ROM 43, and the network interface 44 correspond to the CPU 21, the RAM 22, the ROM 23, and the network interface 24, respectively. In addition, the RAM 42 includes a table 421 for storing a server ID for each server 2 included in the server system 1 in association with a serial number of a rewriting PDU transmitted to the corresponding server 2.

The memory 244 of the network interface 24 of the replacing server 2 has an area 2445 for storing information corresponding to the serial number included in the rewriting PDU.

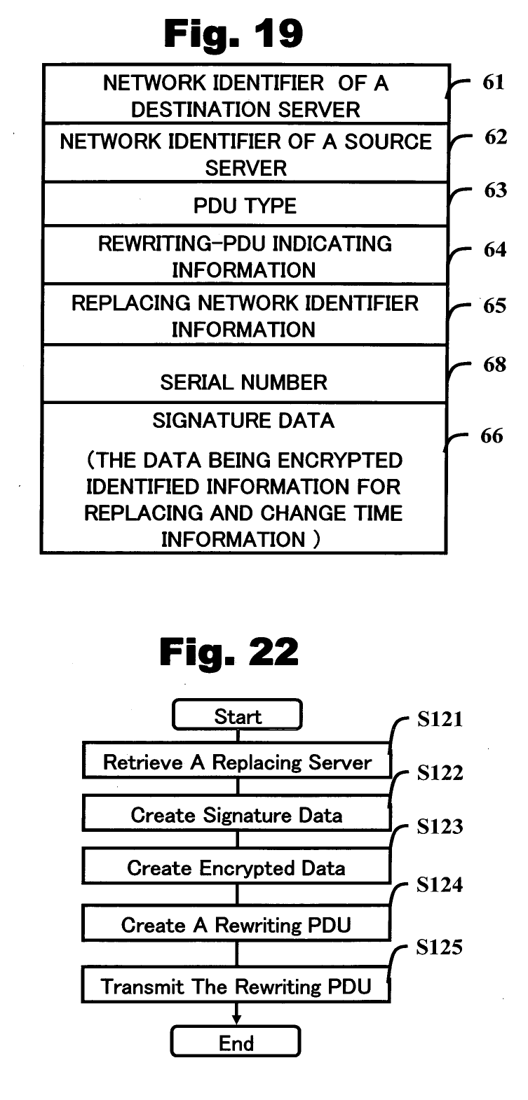

FIG. 18 is a flowchart of a process executed by the management server 4 in a case of preventing reuse of a rewriting PDU using a serial number. The management server 4 retrieves a replacing server (S101). The management server 4 retrieves a serial number for a server corresponding to the replacing server in the table 421 that stores serial numbers. The management server 4 includes the retrieved serial number in the signature data (S102). The management server 4 then creates a rewriting PDU (S103). FIG. 19 shows an example structure of a rewriting PDU. The rewriting PDU includes a network identifier 61 of a destination server 2, a network identifier 62 of a source server 2, a type 63 indicating a type of data protocol, rewriting PDU indicating information 64, replacing network identifier information 65, a serial number 68, and the signature data 66. The management server 4 then transmits the rewriting PDU (S104). The management server 4 changes the retrieved serial number according to a predetermined method, and updates the serial number stored in the table 4421 using the changed serial number (S105). The predetermined method may be, for example, addition of 1 to the original serial number or subtraction of 1 from the original serial number.

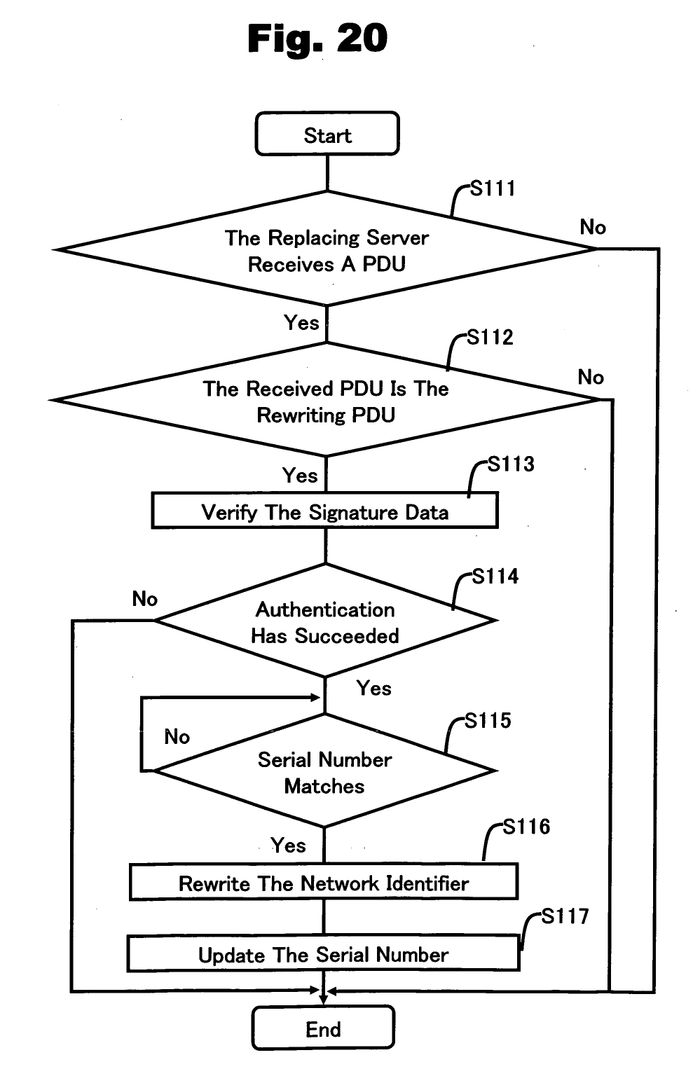

FIG. 20 is a flowchart of a process executed by the replacing server in the case of adopting the packet-reuse preventing function in addition to the authentication function.

Upon the network interface 24 of the replacing server receiving a PDU (YES of S111), the analyzing module 243 determines whether or not the received PDU is the rewriting PDU (S112). If the received PDU is the rewriting PDU (YES of S112), the analyzing module 243 verifies the signature data (S113). The verification of the signature data is performed by decrypting the signature data using a public key 2444 stored in the memory 244 and determining whether or not the network identifier included in the decrypted signature data matches the network identifier included in the rewriting PDU. The analyzing module 243 also determines whether or not the serial number included in the decrypted signature data matches the serial number included in the rewriting PDU. If the network identifiers and the serial numbers match, the analyzing module 243 determines that the authentication has succeeded (YES of S114).

The analyzing module 243 reads out the serial number 2445 stored in the memory 244. The analyzing module 243 determines whether or not the serial number 2445 matches the serial number 68 of the rewriting PDU (S115). If the serial numbers match (YES of S115), the analyzing module 243 rewrites the network identifier stored in the memory 244 to the received network identifier 65 (S116). The analyzing module 243 changes the retrieved serial number according to a predetermined method, and updates the serial number of the memory 244 by the changed serial number (S117). Any methods can be employed at this time as long as input and output values of the replacing server 2 and input and output values of the management server 4 show the same results.

The above-described configuration can prevent a network identifier of the server 2 from being changed using an invalid rewriting PDU transmitted from an unspecified server 2. Furthermore, since the serial numbers have to match, it is possible to prevent the rewriting PDU from being reused.

A case where a replacing network identifier is made invisible in a rewriting PDU will be described next. To make the replacing network identifier invisible in a PDU, authentication and encryption are employed in combination. Although description will be given for an example using public key cryptography for this encryption, the encryption employed in the present invention is not limited to the public key cryptography.

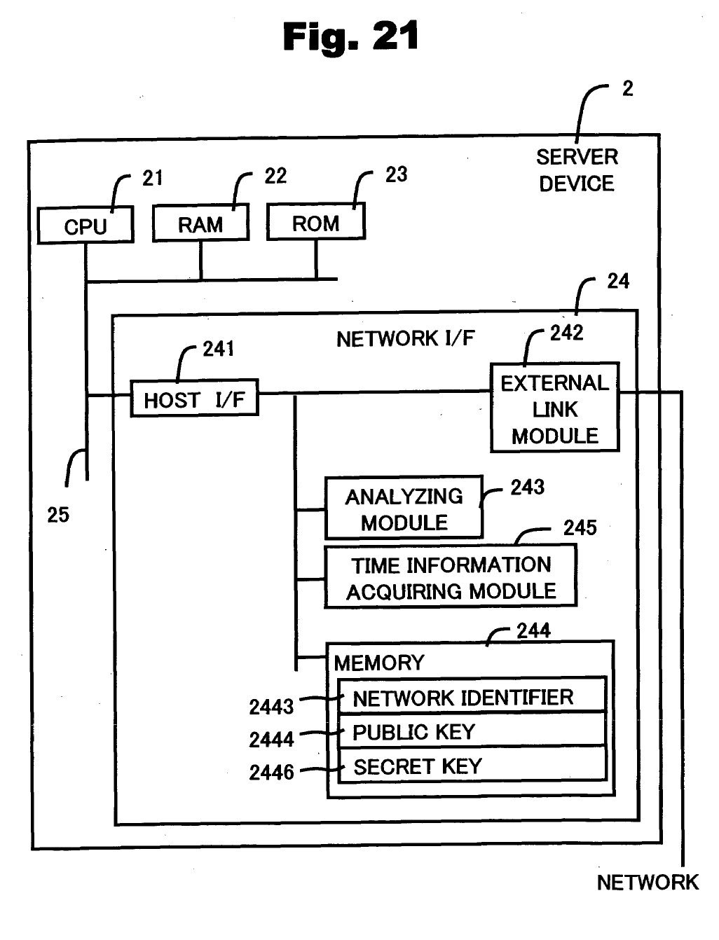

FIG. 21 shows an example of a configuration of a replacing server employed in a case of making a replacing network identifier invisible in a rewriting PDU. A memory 244 of a network interface 24 has an area for storing secret key information 2446. The management server 4 has public key information corresponding to the secret key information 2446. Since other configurations of the server 2 are similar to those shown in FIG. 14, description thereof is omitted.

FIG. 22 is a flowchart of a process executed by the management server 4 in a case of making a replacing network identifier invisible in a rewriting PDU.

The management server 4 retrieves a replacing server (S121). The management server 4 creates signature data 66 including the retrieved network identifier (S122). The management server 4 creates encrypted data including replacing network identifier information 65 of a destination server, time information 67, and signature data 66 shown in FIG. 19 (S123). The management server 4 encrypts data using the public key information corresponding to the secret key information 2446 stored in the replacing server to create the encrypted data.

The management server 4 creates a rewriting PDU including a network identifier 61 of a destination server 2, a network identifier 62 of a source server 2, a type 63 indicating a type of data protocol, rewriting PDU indicating information 64, and the encrypted data (S124). The management server 4 then transmits the rewriting PDU (S125).

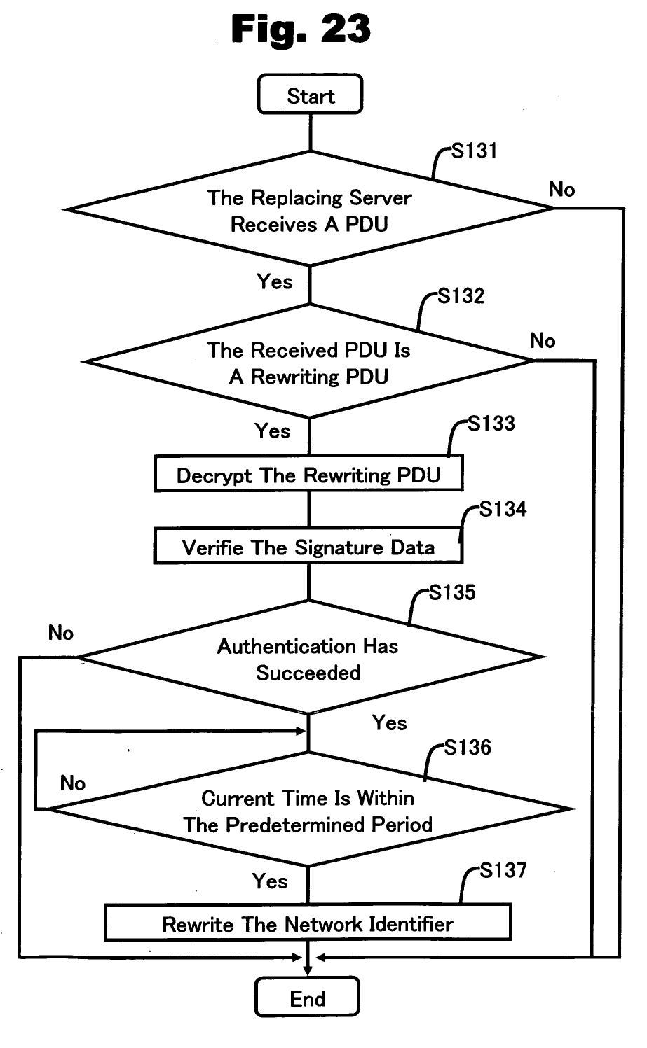

FIG. 23 is a flowchart of a process executed by the replacing server in a case of making a replacing network identifier invisible in a rewriting PDU.

Upon the network interface 24 of the replacing server receiving a PDU (YES of S131), the analyzing module 243 determines whether or not the received PDU is a rewriting PDU (S132).

If the received PDU is the rewriting PDU (YES of S132), the analyzing module 243 decrypts the rewriting PDU (S133). At this time, the analyzing module 243 decrypts the PDU using the secret key information 2446 stored in the memory 244. The analyzing module 243 functions as a decrypting module. The analyzing module 243 verifies the signature data (S134). The verification of the signature data is performed by decrypting the signature data using a public key 2444 stored in the memory 244 and determining whether or not the network identifier included in the decrypted signature data matches the network identifier included in the rewriting PDU.

If the network identifiers match, the analyzing module 243 determines that the authentication has succeeded (YES of S135). The analyzing module 243 acquires the current time from the time information acquiring module 245. The analyzing module 243 determines whether or not the current time is a time after a time indicated by the change time information 67 included in the rewriting PDU and is a time before a time obtained by adding a predetermined change permitted period to the change time information 67 (S136). If the current time is within the predetermined period from the change time information 67 (YES of S136), the analyzing module 243 rewrites the network identifier stored in the storage area of the memory 244 to the received network identifier 65 (S137).

The above-described configuration allows a rewriting PDU to be transmitted without a replacing network identifier being known in the server system 1.

A method for causing a CPU 21 of a server 2 to boot the server, to execute processing for changing a network identifier, and then to reboot the server can be considered as another method for rewriting a network identifier of a replacing server.

What is claimed is:

1. An apparatus connectable to a storage device through a network, comprising:
a network interface module for connecting the apparatus to the storage device through the network;
a memory for storing identification information identifying said network interface module in said network;
a receiving module for receiving set up information including identification information identifying said network interface module through said network; and
a controller for writing said identifying information into the memory on the basis of said set up information.

2. The apparatus according to claim 1, wherein said network interface module connects to the storage device by use of said identifying information written by said controller when said apparatus connects to said network next time.

3. The apparatus according to claim 1, wherein said receiving module receives said set up information when said apparatus is in standby state.

4. The apparatus according to claim 1, further comprising, a decrypting module for decrypting the set up information by public key information corresponding to secret key information when said apparatus receives said set up information including said identification information and said identification information encrypted by said secret key information.

5. The apparatus according to claim 1, further comprising, a time acquiring module for obtaining time information, wherein when said receiving module receives the set up information including time period information indicating a time period during which the identification information is valid, said controller converts said identification information when said time period information matches the time information acquired from said time acquiring module is within the time period indicated by the time period information.

6. A method of controlling an apparatus connectable to a storage device through a network, comprising:
storing identification information identifying said network interface module in said network;
receiving set up information including identification information identifying said network interface module through said network; and
writing said identifying information into the memory on the basis of said set up information.

7. The method according to claim 6, further comprising, connecting to the storage device by use of said identifying information written by the step of writing when said apparatus connects to said network next time.

8. The method according to claim 6, wherein said receiving module receives said set up information when said apparatus is in standby state.

9. The method according to claim 6, further comprising, decrypting the receiving information by public key information corresponding to secret key information when said apparatus receives said set up information including said identification information and said identification information encrypted by said secret key information.
